(19) United States
(12) Patent Application Publication
(10) Pub. No.: US 2024/0367080 A1
(43) Pub. Date: Nov. 7, 2024

(54) FILTER ELEMENT COMPRISING A FILTER MEDIUM FOLDED IN A ZIGZAG SHAPE, AND FILTER SYSTEM

(71) Applicant: MANN+HUMMEL GmbH, Ludwigsburg (DE)

(72) Inventor: Daniel SCHMID, Sachsenheim (DE)

(21) Appl. No.: 18/775,080

(22) Filed: Jul. 17, 2024

Related U.S. Application Data
(63) Continuation of application No. PCT/EP2022/079730, filed on Oct. 25, 2022.

(30) Foreign Application Priority Data
Jan. 28, 2022 (DE) 102022102013.4

(51) Int. Cl. B01D 46/00; B01D 46/52

(52) U.S. Cl. CPC B01D 46/0002; B01D 46/521; B01D 2265/06; B01D 2271/02

(57) ABSTRACT

A filter element for a filter system for filtering a fluid has a filter body with a zigzag-folded filter medium. A frame element and a seal connected to the frame element circumferentially surround a clean-side end face of the filter body. A lattice structure is arranged at the clean-side end face of the filter body. The frame element has a circumferentially extending annular structure connected by a connection structure to the lattice structure. The connection structure is embedded in the seal and has radially extending passages for interlocking seal and frame element. A sleeve surrounds, at least in sections, a wall surface of the filter body in axial direction and in the circumferential direction. The frame element is connected to the sleeve. A filter system is provided with such an exchangeable filter element.

### CROSS-REFERENCE TO RELATED APPLICATIONS

This application is a continuation application of international application No. PCT/EP2022/079730 having an international filing date of Oct. 25, 2022, and designating the United States, the international application claiming a priority date of Jan. 28, 2022, based on prior filed German patent application No. 10 2022 102 013.4, the entire contents of the aforesaid international application and the aforesaid German patent application being incorporated herein by reference.

### BACKGROUND

The invention concerns a filter element for a filter system for filtering a fluid, for example air, comprising a filter body with a filter medium folded in a zigzag shape as well as a filter system for filtering a fluid, for example air, with an exchangeable filter element.

The intake air of combustion engines, prior to entering the motor, is usually guided through an air filter with a filter housing and a filter element arranged therein in order to separate dirt particles contained in the intake air from the intake air itself. Such an air filter is disclosed, for example, in DE 102 31 696 A1. The filter element comprises the shape of a flat cuboid and comprises a filter medium of paper or filter nonwoven which is folded in a zigzag shape. The folds at one side of the filter medium delimit a main filter surface for the raw air side of the filter element and the folds of the opposite side of the filter element positioned in a parallel plane delimit the filter surface for the clean air side. A necessary sealing of the fold ends of the filter medium is achieved by means of a so-called end edge bonding which can be realized, for example, by applying a hot melt bead on the filter medium, spray bonding, PUR foam application or a so-called lateral band bonding.

DE 10 2016 217 458 A1 discloses a trapezoidal or triangular air filter insert with a filter material folded in a zigzag shape, which comprises no parallel lateral edges but tapers in one direction. In the region of the lateral edges, sealing adhesive tracks extend orthogonally to the fold axes and offset relative to each other in axial direction. Neighboring adhesive tracks do not bond common folds but can end at a convex fold apex of adjoining folds.

US 2018/0207566 A1 describes a filter with a filter medium folded to deep folds, wherein the folds can be held spaced apart from each other by adhesive tracks. Radial outer sides which are positioned opposite each other can be sealed by a circumferentially extending adhesive bead which follows a curved course of the outer sides.

### SUMMARY

It is an object of the invention to provide a robust and cost-efficient filter element for a filter system.

A further object is providing a filter system with such a robust and cost-efficient filter element.

The aforementioned object is solved according to an aspect of the invention by a filter element for a filter system for filtering a fluid, for example air, comprising a filter body with a filter medium folded in a zigzag shape, which, when used as intended, is flowed through by the fluid in a flow direction, wherein at least a clean-side end face of the filter body is circumferentially surrounded by a frame element with a seal in a circumferential direction, wherein the frame element comprises a circumferentially extending annular structure which is connected by a connection structure to a lattice structure arranged at the end face of the filter body, and wherein the connection structure is embedded at least partially in the seal, wherein the connection structure comprises radially extending passages for interlocking the seal and the frame element.

The further object is solved by a filter system for filtering a fluid, for example air, comprising an exchangeable filter element according to the invention and a filter housing with a fluid inlet and a fluid outlet, wherein the filter element comprises a filter body with a filter medium folded in a zigzag shape, which, when used as intended, is flowed through by the fluid in a flow direction, wherein at least a clean-side end face of the filter body is circumferentially surrounded by a frame element with a seal in a circumferential direction, wherein the frame element comprises a circumferentially extending annular structure which is connected by a connection structure to a lattice structure arranged at the end face of the filter body, and wherein the connection structure is embedded at least partially in the seal, wherein the connection structure comprises radially extending passages for interlocking the seal and the frame element.

Beneficial embodiments and advantages of the invention result from the further claims, the description, and the drawing.

According to an aspect of the invention, a filter element for a filter system for filtering a fluid, for example air, is proposed, comprising a filter body with a filter medium folded in a zigzag shape, which, when used as intended, is flowed through by the fluid in a flow direction, wherein at least a clean-side end face of the filter body is circumferentially surrounded by a frame element with a seal in a circumferential direction. The frame element comprises a circumferentially extending annular structure which is connected by a connection structure to an inner annular structure which is arranged at the end face of the filter body, and wherein the connection structure is embedded at least partially in the seal. In this context, the connection structure comprises radially extending passages for interlocking the seal and the frame element. In this context, a plurality of passages are provided which may be arranged uniformly distributed about the circumference of the frame element.

The frame element can be embodied as a one-piece plastic component which protects and stabilizes the filter body at the outflow side. The circumferentially extending annular structure is immersed radially in the seal, which can be embodied as a polyurethane (PUR) seal, in order to absorb in this way the radial forces of the seal and to increase the sealing force.

By means of the passages, a strong mechanical interlocking between frame element and seal can be achieved. This is advantageous because, for example, cost-efficient polypropylene (PP) can be used as a material for the frame element, which does not chemically bond to the PUR seal in contrast to the more expensive polyamide (PA) as a material.

Furthermore, a lattice structure, which is arranged at the end face of the filter body and mechanically supports and stabilizes the filter body at the outflow side, can be connected to the frame element.

The frame element is connected to a sleeve which protects the filter body at its radial wall surface.

In addition, additional elements such as guide elements and/or grip elements for guiding the filter element upon installation in a filter housing and/or for holding the filter element upon installation or removal from a filter housing can be arranged at the frame element. These additional elements can be used advantageously for servicing tasks.

Advantageously, the functions such as protection of the filter body at the outflow side, absorbing the forces of the radial seal, protection of the radial wall surface and structures for guiding, holding, and gripping in the service situation can be combined in one plastic component. Due to the integration of the functions in one component, significant cost savings when producing the filter element can be achieved.

According to a beneficial embodiment of the filter element, the circumferentially extending annular structure can be embedded in the seal at least in radial direction. In this way, the annular structure can absorb advantageously radial support forces of the seal.

According to a beneficial embodiment of the filter element, the seal can be connected to folds of the filter body. For example, the seal can be foamed onto folds of the filter body. In this manner, the seal can be permanently and reliably connected to the folds of the filter body. In addition, it can be ensured that the folds can be reliably sealed even at the outer edges or in regions where the folds may be trimmed.

According to a beneficial embodiment of the filter element, the frame element can comprise a lattice structure which is connected to the annular structure and which covers the clean-side end face completely. For example, the lattice structure can be formed together with the annular structure as one piece. The lattice structure supports and stabilizes the end face of the filter body advantageously against the pressure of the flowing fluid.

The frame element is connected to a sleeve which surrounds at least in sections a wall surface of the filter body in axial direction and/or in circumferential direction. In this manner, on the one hand, the sensitive filter medium can be mechanically protected. On the other hand, folds which are open in the direction toward the wall surface can be sealed by the sleeve.

According to a beneficial embodiment of the filter element, the sleeve can comprise at least a, for example maximum, height in an axial direction, which corresponds to 30%, 50%, 70%, 80%, or 90%, of a height of the wall surface. In this way, the wall surface of the filter body can be sufficiently mechanically protected from damage.

According to a beneficial embodiment of the filter element, the sleeve can be connected continuously in circumferential direction to the annular structure. In such an arrangement, the annular structure can pass seamlessly into the sleeve. Despite of this, a sufficient interlocking of the seal and the frame element is possible by means of passages.

According to a beneficial embodiment of the filter element, the sleeve can comprise at least one guide element for assisting in the positioning action in a filter housing. For example, the guide element can be arranged oriented outwardly in a radial direction at the sleeve. By means of the guide element, a suitable guiding action for the reliable positioning of the filter element in a filter housing can be achieved. The guide element can be embodied, for example, in the form of a round pin but also in the form of an ascending incline.

According to a beneficial embodiment of the filter element, the sleeve can comprise at least one grip element, wherein the grip element is arranged oriented outwardly in a radial direction at the sleeve. The grip element can serve advantageously for safely gripping the filter element upon installation in a filter housing or upon removal from the filter housing.

For example, the sleeve can comprise circumferentially a constant height or, alternatively, a height which varies in sections circumferentially, wherein the height can be selected in sections such that, for example, guide element(s) and/or grip element(s) can be arranged at the sleeve at the in relation to their selected axial position.

According to a beneficial embodiment of the filter element, the frame element can be formed as one piece together with the lattice structure and/or sleeve and/or guide element and/or grip element. Due to the one-piece construction, a cost-efficient manufacture of the frame element with the additional elements can be achieved.

It is for example beneficial when at least the annular structure and the connection structure of the frame element (optionally also the lattice structure) and the sleeve are of a one-piece configuration and comprised of a plastic material, for example a hard plastic material, so that the aforementioned device components can be produced for example in a common process step, for example by injection molding.

According to a beneficial embodiment of the filter element, a raw-side end face of the filter body can be circumferentially surrounded by a frame in the circumferential direction. At the raw side, the filter body can be framed by a circumferentially extending frame. The frame can serve for raw-side sealing and stabilization or protection of the filter body. The raw-side frame may be arranged axially spaced apart from the optionally present sleeve.

According to a beneficial embodiment of the filter element, the filter body can comprise an oval, round, or rectangular cross section on at least one part of its cross-sectional surface. For example, the filter body can thus be configured as an oval with two parallel sides. However, other shapes can also be realized advantageously.

According to beneficial embodiment of the filter element, the seal can be embodied in radial direction inwardly with steps parallel to the clean-side end face. Due to the configuration of the seal with steps, rim regions of the folds of the folded filter body can be safely sealed also, for example.

According to a further aspect of the invention, a filter system for filtering a fluid, for example air, comprising an exchangeable filter element and a filter housing with a fluid inlet and a fluid outlet is proposed, wherein the filter element comprises a filter body with a filter medium folded in a zigzag shape, which, when used as intended, is flowed through by the fluid in a flow direction. In this context, at least one clean-side end face of the filter body is circumferentially surrounded by a frame element with a seal in a circumferential direction. The frame element comprises a circumferentially extending annular structure which by a connection structure is connected to a lattice structure which is arranged at the end face of the filter body, and wherein the connection structure is embedded at least partially in the seal. The connection structure comprises radially extending passages for interlocking the seal and the frame element.

Advantageously, a filter element which comprises a frame element can be used in the proposed filter system. The frame element can be embodied as a one-piece plastic component which protects and stabilizes the filter body at the outflow side. The annular structure is immersed radially in the seal, which can be embodied as a polyurethane (PUR) seal, in order to thus absorb the radial forces of the seal and to increase the sealing force.

By means of the passages, a strong mechanical interlocking between frame element and seal can be achieved. This is advantageous because in this way, for example, cost-efficient polypropylene (PP) can be used as a material for the frame element which does not bond chemically to the PUR seal in contrast to the more expensive polyamide (PA) as a material.

The lattice structure to which the frame element is connected stabilizes the filter body at the outflow side and supports it mechanically.

Furthermore, the frame element is connected to a sleeve which protects the filter body at its radial wall surface.

In addition, additional elements such as guide elements and/or grip elements for guiding the filter element upon installation in a filter housing and/or for holding the filter element upon installation or removal from the filter housing can be arranged at the frame element. These additional elements can be used advantageously for servicing tasks.

Advantageously, the functions such as protection of the filter body at the outflow side, absorbing the forces of the radial seal, protection of the radial wall surface and structures for guiding, holding, and gripping in the service situation can be combined in one plastic component. Due to the integration of the functions in one component, significant cost savings can be achieved in regard to the manufacture of the filter element and thus of the filter system.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features expediently also individually and combine them to expedient further combinations.

FIG. 1 shows a partially sectioned isometric view of a filter element according to an embodiment of the invention with marked details A and B.

FIG. 2 shows an enlarged illustration of the detail A of the filter element according to FIG. 1.

FIG. 3 shows an enlarged illustration of the detail B of the filter element according to FIG. 1.

FIG. 4 shows a differently sectioned isometric view of the filter element according to FIG. 1 with marked details C and D.

FIG. 5 shows an enlarged illustration of the detail C of the filter element according to FIG. 4.

FIG. 6 shows an enlarged illustration of the detail D of the filter element according to FIG. 4.

FIG. 7 shows the isometric view of the filter element according to FIG. 4 without seal.

FIG. 8 shows an isometric view of the frame element with sleeve of the filter element.

FIG. 9 shows a detail of the frame element according to FIG. 8.

FIG. 10 shows an isometric view of the filter body of the filter element.

FIG. 11 shows an isometric view of a filter system with mounted filter element according to an embodiment of the invention in a longitudinal section.

### DETAILED DESCRIPTION

In the Figures, same or same-type components are identified with same reference characters. The Figures show only examples and are not to be understood as limiting.

Directional terminology used in the following with terms such as “left”, “right”, “top”, “bottom”, “in front of”, “behind”, “subsequent” and the like serve only for better understanding the Figures and are not to be understood in any case as a limitation of the generality. The illustrated components and elements, their configuration and use can be varied in the context of considerations of a person of skill in the art and adapted to the respective applications.

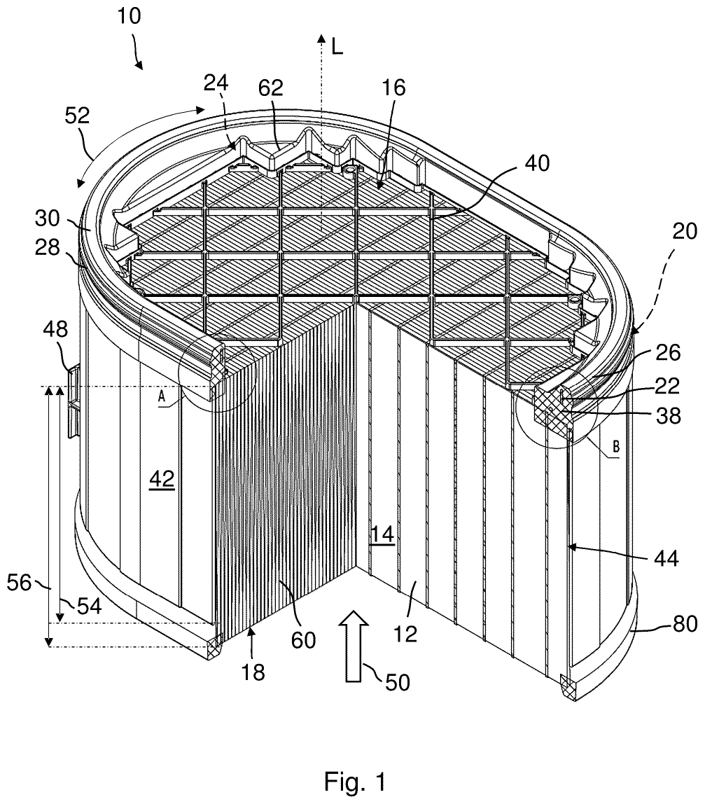

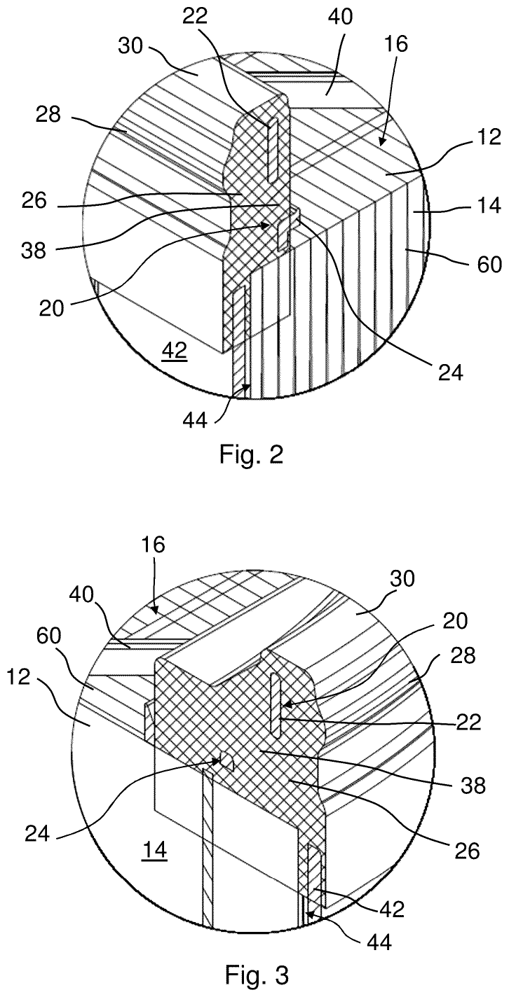

FIG. 1 shows a partially sectioned isometric view of a filter element 10 according to an embodiment of the invention with marked details A and B. FIG. 2 shows an enlarged illustration of the detail A while an enlarged illustration of the detail B is illustrated in FIG. 3.

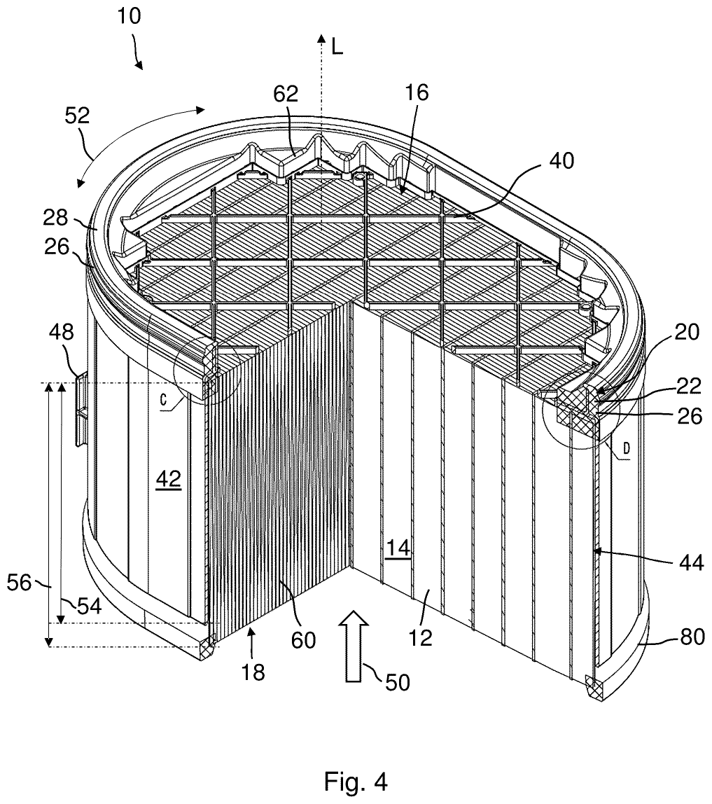

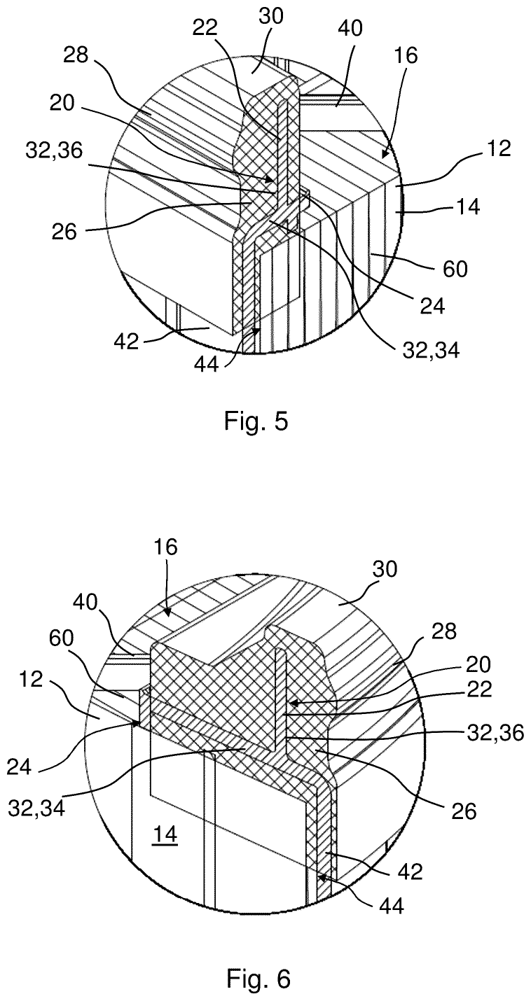

FIG. 4 shows a differently sectioned isometric view of the filter element 10 according to FIG. 1 with marked details C and D. FIG. 5 shows an enlarged illustration of the detail C while an enlarged illustration of the detail D is illustrated in FIG. 6.

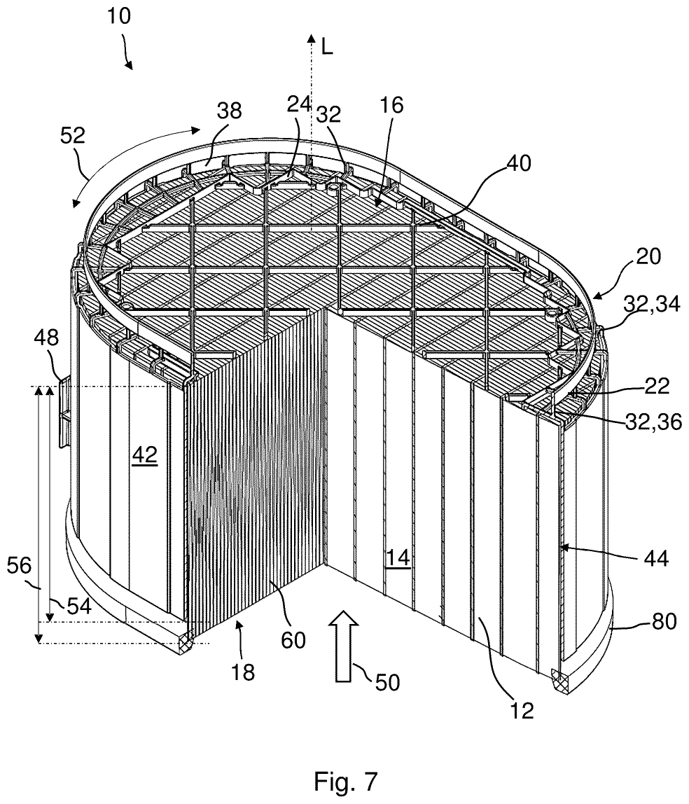

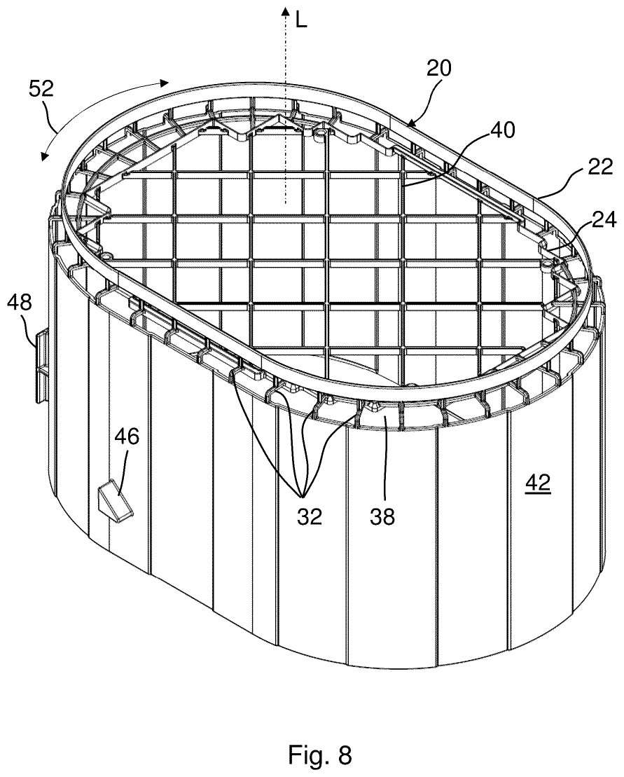

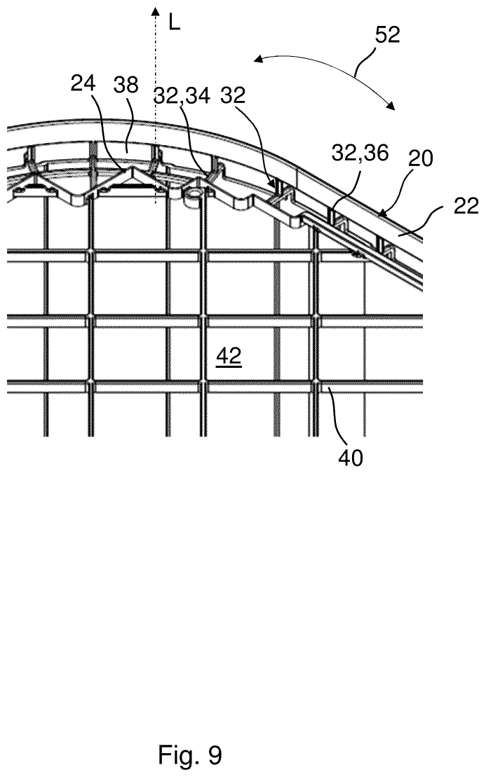

FIG. 7 shows the isometric view of the filter element 10 without seal 26 while an isometric view of the frame element 20 with sleeve 42 of the filter element 10 is illustrated in FIG. 8. FIG. 9 shows a detail of the frame element according to FIG. 8.

The filter element 10 for filtering a fluid, for example air, comprises a filter body 12 with a filter medium 14 folded in a zigzag shape which, when used as intended, can be flowed through by the fluid in a flow direction 50 (illustrated as an arrow). In this context, at least a clean-side end face 16 of the filter body 12 is circumferentially surrounded by a frame element 20 with a seal 26 in a circumferential direction 52. The frame element 20 comprises a circumferentially extending annular structure 22 which is connected by a connection structure 32, for example, by posts 36 and bridges 34, to a lattice structure 40 which is arranged at the clean-side end face 16 of the filter body 12 (see FIG. 7). The connection structure 32 is embedded at least partially, for example at least in radial direction, in the seal 26. The connection structure 32 comprises between the bridges 34 and posts 36 radially extending passages 38 for interlocking the seal 26 and the frame element 20. The circumferentially extending annular structure 22 is arranged in flow direction axially behind the outflow-side end face and is axially spaced apart therefrom. Furthermore, the circumferentially extending annular structure 22 is radially inwardly displaced in relation to the outer wall surface 44 of the filter medium 14, i.e., the circumferentially extending annular structure 22 comprises a smaller circumference than the wall surface 44.

The seal 26 which may be formed of PUR is connected to folds 60 of the filter body 12, for example is foamed onto folds 60 of the filter body 12.

The frame element 20 comprises thus a lattice structure 40 which is connected to the annular structure 22 and which covers the clean-side end face 16. For example, the lattice structure 40 can be formed as one piece together with the annular structure 22. Advantageously, the lattice structure 40 supports and stabilizes the end face 16 of the filter body 12 against the pressure of the flowing fluid.

The frame element 20 may be connected furthermore to a sleeve 42 which surrounds, at least in sections, a wall surface 44 of the filter body 12 in axial direction L and in circumferential direction 52. The sleeve 42 can comprise for example in an axial direction L at least a, for example maximum, height 54 which corresponds to 30%, 50%, 70%, 80%, or 90%, of a height 56 of the wall surface 44.

The sleeve 42 comprises at least one grip element 48 which is arranged oriented outwardly in a radial direction at the sleeve 42. By means of the grip element 48, the filter element 10 can be expediently inserted into a filter housing or removed therefrom.

For example, the sleeve 42 can comprise circumferentially a constant height 54 or, alternatively, a height 54 which varies in sections circumferentially (not illustrated in the Figures), wherein the height 54 can be selected in sections such that, for example, guide element(s) 46 and/or grip element(s) 48 in relation to their selected axial position can be joined at the in axial direction L. In the embodiment illustrated in the Figures, for example, in the region in which the grip element 48 may be arranged at the sleeve 42, a height 54 of at least 70% of the wall surface 44 can be selected in sections, for example.

The raw-side end face 18 of the filter body 12 may be circumferentially surrounded by a frame 80 in the circumferential direction 52. The frame 80 can serve for raw-side sealing and stabilization or protection of the filter body 12.

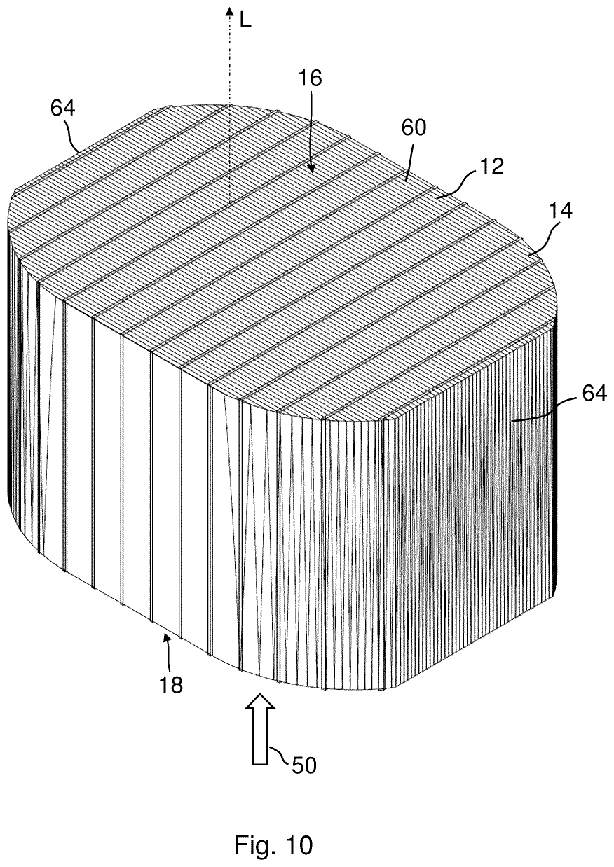

The seal 26 may be embodied in radial direction inwardly with steps 62 parallel to the clean-side end face 16. The steps 62 are realized, for example, by an inner annular structure 24 connected additionally to the frame element 20. The inner annular structure 24 predetermines in this context the step-shaped regions 62 for foaming the PUR seal 26. Due to the configuration of the seal 26 with steps 62, for example, rim regions of the folds 60 of the folded filter body 12 can be safely sealed also. The steps 62 are for example arranged in the rounded regions of the oval filter body 12 at the inner annular structure 24 and seal thus reliably trimmed sections 64 (see FIG. 10) of the filter body 12.

In the enlarged illustration of the detail A in FIG. 2, the annular structure 22 embedded in the seal 26 can be seen. A sectioned inner annular structure 24 can be seen at the filter body 12. Between annular structure 22 and inner annular structure 24, a passage 38 may be formed through which the PUR seal 26 can pass. Axially from below, the sleeve 42 penetrates into the seal 26. The inner annular structure 24 projects out from the seal 26 radially inwardly.

The seal 26 comprises an axial seal surface 30 and a radial seal surface 28 for the installation in a filter housing. For example, the radial seal surface 28 may be supported by the counter force of the annular structure 22 when the filter element 10 is installed as intended.

In the enlarged illustration of the detail B in FIG. 3, again the sectioned annular structure 22 and the sectioned inner annular structure 24 with an intermediately positioned passage 38 can be seen. The seal 26 projects here radially farther inwardly because here the seal 26 is illustrated in the stepped region of the seal 26.

In FIGS. 2 and 3, respective sectioned regions of the lattice structure 40 can be seen which support the folds 60 of the filter body 12 at the clean-side end face 16.

In the enlarged illustration of the detail C in FIG. 5, the annular structure 22 passes via the post 36 of the connection structure 32 directly into the bridge 34 of the connection structure 32 which may be connected to the inner annular structure 24 and which, in turn, directly passes into the sleeve 42. Advantageously, the sleeve 42 can thus be continuously connected to the annular structure 22 in circumferential direction 52.

This can be seen also in the enlarged illustration of the detail D in FIG. 6, wherein here the inner annular structure 24 in the stepped region of the seal projects farther inwardly in radial direction. In this way, the bridge 34 is embodied longer between the post 36 or the sleeve 42 and the inner annular structure 24.

In the illustration of the filter element 10 without seal 26 in FIG. 7, the stepped course of the inner annular structure 24 which predetermines the course for the seal 26 can be seen clearly. The annular structure 22 may be connected by the bridges 34 and posts 36 of the connection structure 32 to the inner annular structure 24.

For reasons of clarity, only one element of same elements is identified with a reference character.

In FIG. 8, where the frame element 20 with lattice structure 40 and sleeve 42 is illustrated without the filter body 12, at least one guide element 46 can be seen at the sleeve 42 for assisting in the positioning action in a filter housing 110. The guide element 46 may be arranged oriented outwardly in a radial direction at the sleeve 42 and comprises an ascending ramp shape. Alternatively, the guide element 46 can also be embodied as a round pin, for example.

Advantageously, the frame element 20 can be formed as one piece together with lattice structure 40 and/or sleeve 42 and/or guide element 46 and/or grip element 48. In this way, a cost-efficient manufacture of the frame element 20 with additional elements is possible.

FIG. 9 shows a detail of the frame element according to FIG. 8 in enlarged illustration. The connection of the circumferentially extending annular structure 22 by the posts 36 and bridges 34 to the sleeve 42 or to the inner annular structure 24 and the lattice structure 40 can thus be seen more clearly.

FIG. 10 shows an isometric illustration of the filter body 12 of the filter element 10 according to FIG. 1. The filter body 12 comprises on at least one part of its cross-sectional surface an oval cross section with two parallel lateral surfaces. The rounded ends of the oval each comprise an additionally trimmed side 64.

In an alternative embodiment, the filter body 12 can however also have a round or rectangular cross section but also a differently embodied cross section.

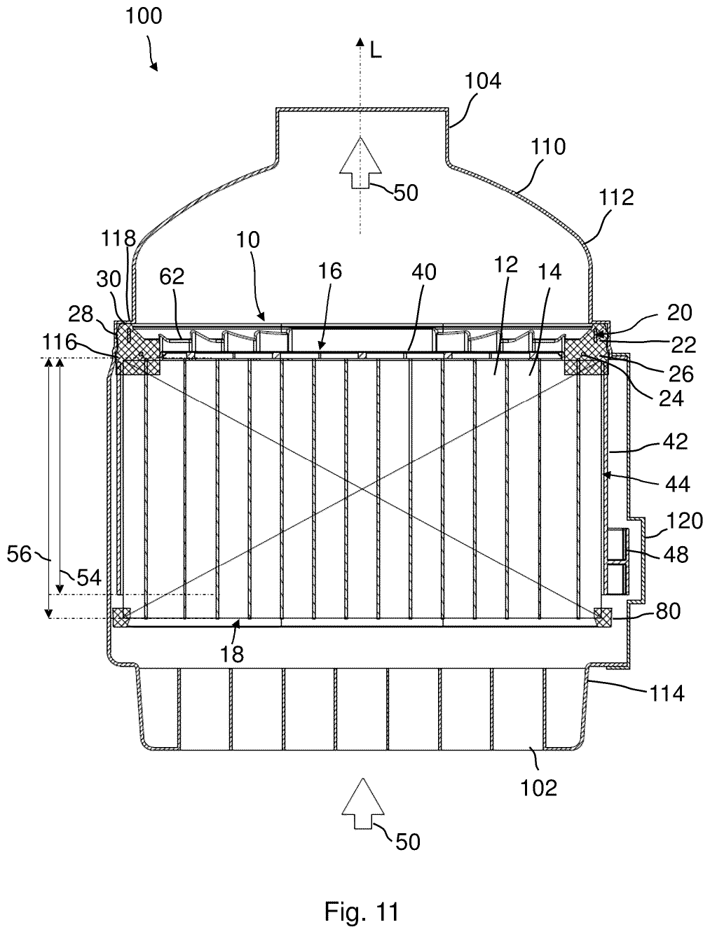

FIG. 11 shows an isometric view of a filter system 100 with mounted filter element 10 according to an embodiment of the invention in a longitudinal section.

The filter system 100 for filtering a fluid, for example air, comprises a filter housing 110 with a fluid inlet 102 and a fluid outlet 104. The filter housing 110 may be comprised of a housing top part 112 and a housing bottom part 114 which are connected detachably to each other in a seal-tight manner and receive the exchangeable filter element 10 in the interior.

The filter element 10 according to an embodiment as illustrated in FIGS. 1 through 10 comprises a filter body 12 with a filter medium 14 folded in a zigzag shape which, when used as intended, is flowed through by the fluid in the flow direction 50. The flow direction 50 is indicated by arrows.

It can be seen how the inserted filter element 10, through the radial seal surface 28 of the seal 26, contacts the housing wall of the filter housing 110 and contacts the shoulder of the filter housing 110 by means of the axial seal surface 30. The annular structure 22 of the frame element 20 supports in this context the seal 26 for example in radial direction.

For the grip element 48 arranged at the sleeve 42, a corresponding receptacle 120 may be provided in the filter housing 110. The filter element 10 may be removable laterally, i.e., transversely to the flow direction 50, from the filter housing 110.

### REFERENCE NUMBERS

10 filter element
12 filter body
14 filter medium
16 clean-side end face
18 raw-side end face
20 frame element
22 annular structure
24 inner annular structure
26 seal
28 radial seal surface
30 axial seal surface
32 connection structure
34 bridge
36 post
38 passage
40 lattice structure
42 sleeve
44 wall surface
46 guide element
48 grip element
50 flow direction
52 circumferential direction
54 height of sleeve
56 height of wall surface
60 fold
62 step
64 trimmed side
80 frame
100 filter system
102 fluid inlet
104 fluid outlet
110 filter housing
112 housing top part
114 housing bottom part
116 housing wall
118 shoulder
120 receptacle
L axial direction

What is claimed is:

1. A filter element for a filter system for filtering a fluid, the filter element comprising:
a filter body comprising a filter medium folded in a zigzag shape, wherein the filter body, when used as intended, is configured to be flowed through by the fluid in a flow direction;
a frame element;
a seal connected to the frame element, wherein the frame element and the seal circumferentially surround a clean-side end face of the filter body in a circumferential direction;
a lattice structure arranged at the clean-side end face of the filter body, wherein the frame element comprises a circumferentially extending annular structure connected by a connection structure to the lattice structure, wherein the connection structure is embedded at least partially in the seal, and wherein the connection structure comprises passages extending in a radial direction and configured to interlock the seal and the frame element;
a sleeve surrounding, at least in sections, a wall surface of the filter body in an axial direction of the filter body and in the circumferential direction, wherein the frame element is connected to the sleeve.

2. The filter element according to claim 1, wherein the circumferentially extending annular structure is embedded at least in a radial direction in the seal.

3. The filter element according to claim 1, wherein the seal is connected to folds of the filter body.

4. The filter element according to claim 3, wherein the seal is foamed onto the folds of the filter body.

5. The filter element according to claim 1, wherein the lattice structure and the circumferentially extending annular structure of the frame element together are formed as one piece.

6. The filter element according to claim 1, wherein the sleeve comprises a sleeve height measured in the axial direction, wherein the sleeve height corresponds to at least 70% of a height of the wall surface.

7. The filter element according to claim 1, wherein the sleeve is connected continuously to the circumferentially extending annular structure in the circumferential direction.

8. The filter element according to claim 1, wherein the sleeve comprises at least one guide element configured to assist in positioning of the filter element in a filter housing.

9. The filter element according to claim 8, wherein the at least one guide element is arranged oriented outwardly in the radial direction at the sleeve.

10. The filter element according to claim 1, wherein the sleeve comprises at least one grip element, wherein the at least one grip element is arranged oriented outwardly in the radial direction at the sleeve.

11. The filter element according to claim 1, wherein the frame element is formed as one piece together with one or more of the elements of the group consisting of the lattice structure, the sleeve, a guide element arranged at the sleeve, and a grip element arranged at the sleeve.

12. The filter element according to claim 1, further comprising a frame circumferentially surrounding a raw-side end face of the filter body in the circumferential direction.

13. The filter element according to claim 1, wherein the filter body comprises on at least one part of a cross-sectional surface thereof an oval cross section, a round cross section or a rectangular cross section.

14. The filter element according to claim 1, wherein the seal comprises steps extending inwardly in the radial direction parallel to the clean-side end face.

15. A filter system for filtering a fluid, the filter system comprising:
a filter housing with a fluid inlet and a fluid outlet; and
an exchangeable filter element according to claim 1 configured to be installed in the filter housing.
